(19) United States
(12) Patent Application Publication
(10) Pub. No.: US 2025/0178092 A1
(43) Pub. Date: Jun. 5, 2025

(54) A METHOD FOR CALIBRATING AN IRRADIATION DEVICE OF AN APPARATUS FOR PRODUCING A THREE-DIMENSIONAL WORKPIECE

(71) Applicant: NIKON SLM SOLUTIONS AG, Luebeck (DE)

(72) Inventors: Christopher Stengel, Luebeck (DE); Jan Wilkes, Luebeck (DE)

(21) Appl. No.: 18/862,029

(22) PCT Filed: Apr. 4, 2023
(86) PCT No.: PCT/EP2023/058808

§ 371 Date: Oct. 31, 2024

(30) Foreign Application Priority Data
Jun. 8, 2022 (DE) 10 2022 114 426.7

(51) Int. Cl. B22F 10/85; B22F 10/31; B22F 10/366; B33Y 10/00; B33Y 30/00; B33Y 50/02

(52) U.S. Cl. CPC B22F 10/85; B22F 10/31; B22F 10/366; B33Y 10/00; B33Y 30/00; B33Y 50/02

(57) ABSTRACT

A method for calibrating an irradiation device of an apparatus for producing a three-dimensional workpiece is provided. The method comprises applying a first powder layer onto a carrier or onto a previously applied powder layer, irradiating the first powder layer with an irradiation beam along at least one first irradiation section, defining a first correction direction having an angle in a range from 70° to 110° with regard to the at least one first irradiation section, obtaining a first image of process radiation at locations where the irradiation beam impinges on the first powder layer during irradiation along the at least one first irradiation section, and determining, based on the first image, a correction value along the first correction direction for calibration of the irradiation device. Further, an apparatus for producing a three-dimensional workpiece and a computer program product are provided.

The present invention generally relates to calibration of an irradiation device. In particular, the present invention is directed to a technique for calibrating an irradiation device of an apparatus for producing a three-dimensional workpiece. The apparatus for producing a three-dimensional workpiece may be, without limitation, an apparatus for additive manufacturing and, more precisely, for powder bed fusion, such as selective laser sintering and/or selective laser melting.

Powder bed fusion is an additive layering process by which pulverulent, in particular polymer, metallic and/or ceramic raw materials can be processed to three-dimensional workpieces of complex shapes. To that end, a raw material powder layer is applied onto a carrier and subjected to radiation (e.g., laser or particle radiation) in a site-selective manner in dependence on the desired geometry of the workpiece that is to be produced. The radiation penetrating into the powder layer causes heating and consequently melting or sintering of the raw material powder particles.

Further raw material powder layers are then applied successively to the layer on the carrier that has already been subjected to radiation treatment, until the workpiece has the desired shape and size. Powder bed fusion may be employed for the production of prototypes, tools, replacement parts, high value components, or medical prostheses, such as, for example, dental or orthopedic prostheses, on the basis of CAD data. Examples for powder bed fusion techniques include selective laser melting and selective laser sintering.

Apparatuses are known for producing one or more workpieces according to the above technique. For example, EP 2 961 549 A1 and EP 2 878 402 A1, respectively, describe an apparatus for producing a three-dimensional workpiece according to the technique of selective laser melting. The general principles described in these documents may also apply to the technique of the present disclosure.

In order to direct and focus the irradiation beam onto a specific predefined spot within the uppermost powder layer, an apparatus for producing a three-dimensional workpiece typically comprises an irradiation device. For this purpose, the irradiation device may comprise an irradiation source (such as a laser source or particle source), focusing optics (for performing focusing along the beam direction, which is substantially the z-direction), and/or scanning optics for moving the irradiation beam within the x-y-plane (corresponding to a plane of the powder layer).

For the case that more than one irradiation spot shall be irradiated (in particular, simultaneously), more than one irradiation device may be provided.

Current irradiation devices (also referred to as scanner heads) include high precision optical components and, therefore, are very expensive. Less expensive irradiation devices may not achieve the required degree of precision (e.g., with regard to long term drift and/or thermal drift, respectively within the x-y plane and/or the z-direction).

Further, in order to eliminate or at least mitigate the effects of imprecise positioning and particularly drift, it is known to perform calibration of the irradiation device. For example, a reference plate with reference marks may be placed into the process chamber and a position of the laser beam with regard to the reference marks may be determined and calibration may be performed on the basis of this determination. This calibration may be carried out, e.g., at the beginning of each build process. Further, it is known to burn a calibration pattern into a calibration film and to observe the generated pattern, e.g., with a camera.

However, known calibration techniques are either not precise enough, too complex, and/or do not enable a calibration that can deal with the strong drift phenomena in the context of low-cost irradiation devices. Further, known calibration techniques often have a disadvantage that they require time, during which no melting process can take place. Thus, the productivity of the apparatus may decrease.

The invention is therefore directed at the object of providing a technique that solves at least one of the aforementioned problems and/or other related problems. In particular, and without limitation, an improved calibration technique for an irradiation device of an apparatus for producing a three-dimensional workpiece is desired.

This object is addressed by the subject-matter of the independent claims. Advantageous embodiments are indicated in the dependent claims.

According to a first aspect, a method for calibrating an irradiation device of an apparatus for producing a three-dimensional workpiece is provided. The method comprises applying a first powder layer onto a carrier or onto a previously applied powder layer, irradiating the first powder layer with an irradiation beam along at least one first irradiation section, defining a first correction direction having an angle in a range from 70° to 110° with regard to the at least one first irradiation section, obtaining a first image of process radiation at locations where the irradiation beam impinges on the first powder layer during irradiation along the at least one first irradiation section, and determining, based on the first image, a correction value along the first correction direction for calibration of the irradiation device.

One or more of the following features of the method aspect may also apply to the apparatus of the apparatus aspect described below.

The method may be carried out by the apparatus for producing the three-dimensional workpiece (in the following: the apparatus). The apparatus may be an additive manufacturing apparatus, e.g., an apparatus for powder bed fusion, such as for selective laser melting or selective laser sintering. In this regard, the apparatus may exhibit the features discussed in the introductory section above. The techniques of selective laser melting and selective laser sintering are techniques well known to the person skilled in the art and will only be described very briefly in the present disclosure.

In particular, a build process carried out by the apparatus may involve depositing a first layer of raw material powder onto a carrier of the apparatus. The first layer (as well as the subsequent layers) may have a predefined layer thickness, wherein the layer thickness may be adjusted from layer to layer or may be fixed. The powder layers may be deposited by any suitable technique, wherein several methods and apparatuses for generating raw material powder layers are known in the art. After having deposited the first raw material powder layer, predefined regions of the powder are irradiated by an irradiation beam (e.g., a laser or electron beam), according to a CAD file, for example. In this way, a first layer of a workpiece to be generated may be irradiated and thereby solidified. In a subsequent step, a second layer of raw material powder is deposited and predefined regions of said second layer are irradiated and solidified. In this way, the workpiece is generated layer by layer.

The method of the first aspect may be carried out for one or more layers of the workpiece to be produced. For example, the method may be carried out for a lowermost layer of the workpiece to be generated or may be carried out every M layers of the workpiece, wherein M is one or more.

When expressions such as “first” and “second” are used in this disclosure, they are merely used in order to linguistically distinguish between the respective features. For example, the “first” powder layer is not necessarily a first powder layer applied on the carrier (since other, preceding powder layers may have been applied before).

The carrier may be a carrier of the apparatus, which is movable or static with regard to the z-direction (perpendicular to a surface of the carrier, which is within an x-y-plane). When the first powder layer is applied onto a previously applied powder layer, this previously applied powder layer may be part of a stack of powder layers applied on the carrier. However, also the case of hybrid manufacturing is encompassed, wherein a part to be repaired or to be finished via powder bed fusion is embedded in a powder bed below the previously applied powder layer. The previously applied powder layer may comprise solidified sections.

Irradiating the first powder layer along the at least one first irradiation section may comprise irradiation with an irradiation beam (e.g., a laser beam or a particle beam such as an electron beam). In particular, a beam source may be provided for generating the irradiation beam, for example, a laser source or a particle source (such as an electron source). When in the following irradiation with a laser beam is discussed, it should be kept in mind that irradiation with different irradiation beams (such as electron beams) is also possible and encompassed by the present disclosure.

Irradiating the first powder layer along the at least one first irradiation section may comprise sintering or melting the powder at locations corresponding to the first irradiation section. In other words, an energy of an irradiation beam used for the irradiating step may be suitable for solidifying the irradiated powder at the locations corresponding to the first irradiation section. The irradiation section may be an irradiation vector, in particular of a workpiece layer. The step of irradiating may be part of a production process of the three-dimensional workpiece. The irradiation vector may be, e.g., part of a hatch pattern of an inner part (core) of the workpiece to be generated. However, the irradiation section may also be a section of a contour of the workpiece to be generated.

In case the irradiation section is an irradiation vector, the irradiation vector is a straight vector along a predefined direction (i.e., along a straight line within the x-y-plane). The irradiation vector has a start point and an end point, wherein the irradiation beam is scanned from the start point to the end point during the irradiating step. The first correction direction may be perpendicular to the at least one first irradiation section. The first correction direction lies within the x-y-plane (i.e., within a plane of the first powder layer). The fact that the first correction direction has an angle in a range from 70° to 110° with regard to the at least one first irradiation section may mean that the first correction direction is almost perpendicular or perpendicular with regard to the first irradiation section. For example, the angle between the first correction direction and the first irradiation section may be in a range from 80° to 100° or in a range from 85° to 95°. The angle may be 90°, such that the first correction direction is perpendicular to the first irradiation section.

When, in the present disclosure, it is stated that a correction direction is “perpendicular” to an irradiation section, an irradiation vector, or a tangential direction of an irradiation section, this means that the angle between the two elements may in fact be 90° or that it is at least in the range from 70° to 110°. Therefore, even if it is not explicitly indicated below, the indicated angle of the two “perpendicular” elements may be 90° or at least in the range from 70° to 110°.

The first image may be a digital image and, therefore, may be represented by digital image data. In particular, the first image may be obtained by a digital camera. An exposure time for the first image may be such that a direction of the first irradiation section can be derived from the first image. In other words, the first image may include a section of the first irradiation section, which is not only an irradiation spot but rather an irradiation line. In particular, the first image may comprise the entire first irradiation section, e . . . g, the entire first irradiation vector (i.e., from its start point to its end point). In other words, an exposure time for the first image may be at least a time required to scan the first irradiation vector from its start point to its end point. However, the first image may include a section of the first irradiation section, from which a direction of the first irradiation section cannot be derived, in particular, since it only shows an irradiation spot. This may be because the exposure time is very short and/or a scanning speed of the laser along the first irradiation section is very slow. In this case, the direction of the first irradiation section may be determined on the basis of control data provided by a control unit of the apparatus, e.g., to a scanning unit of the apparatus. In other words, the direction of the first irradiation section may be derived by the control unit of the apparatus for the purpose of determining the correction value along the correction direction, on the basis of an irradiation pattern and/or a scan strategy stored in the control unit and/or provided to the scanning unit.

The process radiation (captured in the first image) may correspond to scattered laser radiation (i.e., of a wavelength of a laser beam used for the irradiating) or melt pool radiation (such as thermal radiation, e.g., in the visible or infrared wavelength region), or a combination of both. In particular, a filter may be provided to block the laser radiation and to let pass the melt pool radiation, such that the image only includes melt pool radiation.

For determining the correction value, a position of the first irradiation section within the obtained image may be determined, in particular with regard to the first correction direction. The obtained position of the first irradiation section may be compared with a desired position of the first irradiation section, in particular with regard to the first correction direction. The desired position may be an expected position, e.g., a position expected on the basis of a previous calibration.

The correction value along the first correction direction may be a value that can be applied to input data of the irradiation device, to correct an irradiation position along the first correction direction. More precisely, the correction value may be applied to scanner data for controlling a scanning unit of the irradiation device. The correction value may comprise a lateral shift value representing a length (e.g., in mm) or may comprise a linear correction factor or a non-linear correction value.

The method may further comprise carrying out a calibration of the irradiation device along the first correction direction on the basis of the first correction value. Calibration techniques are commonly known and, therefore, will not be discussed in detail in the present disclosure. The calibration may configure the irradiation device such that an actual irradiation position corresponds to a desired irradiation position.

The correction value may be representative of a deviation of an actual irradiation position and a desired irradiation position. After the calibration process, said deviation should be zero or at least minimized.

The calibration may be absolute or relative to another irradiation device. Absolute calibration means a calibration with regard to positions of the powder bed. In particular, with regard to a position of at least one reference mark provided on the carrier or within the process chamber (e.g., on a process chamber floor). Hence, an absolute calibration may mean that a specific desired location of the powder bed can be precisely irradiated. Relative calibration (relative to another irradiation device) means that a position of the irradiation beam of the irradiation device relative to a position of an irradiation beam of a further irradiation device is known. In this way, e.g., both irradiation devices may irradiate precisely the same irradiation spot.

In order to achieve an absolute calibration, an image field correction may be carried out with a camera (optical detection device) used for obtaining the image. For this purpose, a correction plate with reference marks may be used, which is placed in a field of view of the camera, e.g., before the build process begins.

The method may further comprise applying a second powder layer onto the first powder layer or onto a powder layer that has been applied after the first powder layer, irradiating the second powder layer with the irradiation beam along at least one second irradiation section, the second irradiation section being not parallel to the first irradiation section, defining a second correction direction having an angle in a range from 70° to 110° with regard to the at least one second irradiation section, obtaining a second image of process radiation at locations where the irradiation beam impinges on the second powder layer during irradiation along the at least one second irradiation section, and determining, based on the second image, a correction value along the second correction direction for calibration of the irradiation device.

With regard to the irradiation of the second powder layer along the at least one second irradiation section, the same details and/or features may apply as discussed above with regard to the irradiation of the first powder layer along the at least one first irradiation section. In particular, during the irradiation along the second irradiation section, irradiated sections of the second powder layer may melt or sinter and, therefore, may be solidified. Further, the second irradiation section may be an irradiation vector or part of an irradiation vector for producing the three-dimensional workpiece, e.g., part of a hatch pattern of an inner region (core) of the workpiece.

However, the second irradiation section may also be part of a contour of the workpiece.

Further, for obtaining the second image, the same or corresponding details and/or features as discussed above with regard to obtaining the first image may apply. The first image and the second image may be obtained with the same optical detection device (in particular, camera).

Regarding the second correction value along the second correction direction, the same details and/or features as discussed above with regard to the first correction value along the first correction direction may apply accordingly.

The method may further comprise carrying out a calibration of the irradiation device along the second correction direction on the basis of the second correction value.

In this context, it should be noted that calibration with regard to the first correction direction may be carried out before a further powder layer is irradiated subsequent to the first powder layer. More precisely, calibration with regard to the first correction direction may be carried out before the second powder layer is applied. Thus, calibration with regard to the second correction direction may be carried out after calibration with regard to the first correction direction has been carried out. However, alternatively, a combined calibration may be carried out on the basis of the first correction value and the second correction value. In this way, it is not only calibrated along one direction (i.e., the first correction direction) but with regard to the x-y-plane.

Therefore: The method may further comprise carrying out a (combined) calibration of the irradiation device along the first correction direction and along the second correction direction on the basis of both the first correction value and the second correction value.

The second correction direction may be perpendicular to the first correction direction. It should be noted that even in case the second correction direction is not perpendicular to the first correction direction, it is sufficient that an angle between these two directions is larger than zero (in particular, larger than 10° or larger than 20° or larger than) 45°, such that an x-component and a y-component for calibration can be derived, for example.

The first irradiation section may be a straight irradiation vector. The second irradiation section may be a straight irradiation vector.

However, the first and/or second irradiation section may also be a curved section, i.e., a curved line. In this case, the direction of the first and/or second correction direction is determined with regard to a tangential direction of the first and/or second irradiation section. The tangential direction may be determined at a particular point of the section, in particular a point considered for calibration.

The first irradiation section may be a first irradiation vector being part of a first hatch pattern of a first layer of the three-dimensional workpiece to be produced. The second irradiation section may be a second irradiation vector being part of a second hatch pattern of a second layer of the three-dimensional workpiece to be produced.

The first hatch pattern and the second hatch pattern may each comprise a plurality of parallel irradiation vectors.

The first hatch pattern and/or the second hatch pattern may be used as a filling structure for an inner region (core) of the workpiece to be produced. A direction of the irradiation vectors of the first hatch pattern and a direction of the irradiation vectors of the following hatch patterns may be rotated, e.g., for each layer or for every N layers (wherein N is 2 or more), about a predefined angle (e.g., 45° or) 90°.

As already discussed above, since the first and/or second irradiation vector may be part of a respective hatch pattern, the irradiation of the respective (first and/or second) irradiation vector may cause melting (or sintering) and solidification of irradiated sections of the respective powder layer. In other words, the calibration method may be performed in situ, i.e., during a build process of the three-dimensional workpiece.

In this way, a calibration of the irradiation device (or irradiation devices) of the apparatus can be constantly maintained during the build process. Further, time and effort can be saved since no calibration process has to be performed before the build process is started. In this way, less expensive irradiation devices can be used, which exhibit a significant drift during a build process.

The at least one first irradiation vector and the at least one second irradiation vector may form an angle of more than 10°, more than 15°, or more than 20°.

For example, the angle may be 45° or 90°.

The first image may include a start point and an end point of the first irradiation vector.

In particular, this may hold for both time and space aspects. More precisely, a field of view of the camera obtaining the first image may be large enough that the entire first irradiation vector fits into the field of view. Further, an exposure time of the camera may be long enough such that the irradiation of the entire first irradiation vector takes place during the exposure time. The first image may further include one or more further irradiation vectors or one or more sections thereof.

The first irradiation section may be a contour section being part of a contour of the three-dimensional workpiece to be produced.

For example, it may be possible that calibration is carried out with regard to both the x-direction and the y-direction on the basis of one powder layer. For this purpose, either different sections of the contour of the workpiece may be considered, wherein said different sections extend into different directions within the x-y-plane. Further, an irradiation section may be considered which is an irradiation vector of a hatch pattern and a further irradiation section may be considered which is a contour section of the workpiece, wherein the irradiation section and the further irradiation section are not parallel to each other. Additionally, also the second correction value obtained for the second powder layer may be considered.

Using more than two correction values may increase a precision of the calibration.

The contour section is a contour section of the workpiece to be generated. Hence, during irradiation of the contour section, powder is melted (or sintered).

The contour section may be a straight contour section. In other words, the contour section may be a section of the contour of the workpiece, which is a straight line. In this case, the first correction direction is defined perpendicular to said straight contour section. However, the contour section may also be a curved contour section. In this case, the first correction direction is defined perpendicular to a tangential direction of the contour section at a particular point that is part of the first image. Since the contour of the workpiece is usually a closed line, it changes its direction during the irradiation of the contour and, therefore, a full calibration can be performed within the x-y-plane, i.e., not only along one first direction but along several non-parallel first directions.

An optical detection device of the apparatus, which is configured for obtaining the images, may be controlled such that the contour of the workpiece is captured without gaps or almost without gaps. In other words, the optical detection device may be controlled such that it continuously obtains images. This may also apply to the irradiation of the hatch vectors and the determination of correction values with regard to the hatch vectors. Thus, the optical detection device may be controlled such that it continuously obtains images during the irradiation of a hatch pattern including the first irradiation vector and/or during the irradiation of the contour of the three-dimensional workpiece.

The apparatus may comprise an irradiation device for irradiating the irradiation beam and a further irradiation device for irradiating a further irradiation beam. The method may comprise selectively irradiating the further irradiation beam onto the first powder layer. The irradiation device may be configured to scan the irradiation beam over a first scan field and the further irradiation device may be configured to scan the further irradiation beam over a second scan field, at least partially overlapping the first scan field in an overlap area. An optical detection device obtaining the first image may be oriented or orientable such that a field of view of the optical detection device comprises at least a section of the overlap area.

By providing at least two scan fields that at least partially overlap, a three-dimensional workpiece with a large footprint can be generated in a short time since the at least two irradiation beams can simultaneously irradiate in their corresponding scan fields. The optical detection device may be a camera. When the field of view of the optical detection device comprises at least a section of the overlap area, the optical detection device may be used, for example, for a) absolute calibration (i.e., calibration with regard to the powder bed) of both the irradiation device and the further irradiation device, and/or b) relative calibration of the irradiation device and the further irradiation device with regard to each other. For the case a) of absolute calibration, the camera has to be calibrated with regard to the powder bed, i.e., it has to be known, which position in the images obtained by the camera corresponds to which position on the powder bed. This may be done with the help of reference marks, e.g., on a calibration plate.

The irradiation device and the further irradiation device may simultaneously irradiate in the overlap area and may be simultaneously imaged by the optical detection device. Alternatively, the irradiation device and the further irradiation device may sequentially irradiate in the overlap area and may be sequentially imaged by the optical detection device.

A direction of the irradiation section generated by the irradiation device may be different from a direction of an irradiation section generated by the further irradiation device. In this case, the respective correction directions for the irradiation device and the further irradiation device may differ. Hence, the irradiation device may be calibrated along a different direction than the further irradiation device. In general, a calibration of the further irradiation device may be carried out in a manner analogous to the calibration of the irradiation device.

According to a second aspect, an apparatus for producing a three-dimensional workpiece is provided. The apparatus comprises a powder application device configured to apply at least one powder layer onto a carrier or onto a previously applied powder layer, an irradiation device for selectively irradiating an irradiation beam onto an irradiation plane corresponding to the applied powder layer, an optical detection device for optically detecting at least a portion of the irradiation plane, and a control unit. The control unit is configured to instruct the powder application device to apply a first powder layer onto the carrier or onto the previously applied powder layer, instruct the irradiation device to irradiate the first powder layer along at least one first irradiation section, define a first correction direction having an angle in a range from 70° to 110° with regard to the at least one first irradiation section, instruct the optical detection device to obtain a first image of process radiation at locations where the irradiation beam impinges on the first powder layer during irradiation along the at least one first irradiation section, and determine, based on the first image, a correction value along the first correction direction for calibration of the irradiation device.

All details described above in the context of the method of the first aspect may apply accordingly to the apparatus of the second aspect. In other words, the apparatus of the second aspect may be configured to carry out each of the methods of the first aspect described above.

The control unit may be configured to instruct the powder application device to apply a second powder layer onto the first powder layer or onto a powder layer that has been applied after the first powder layer, instruct the irradiation device to irradiate the second powder layer along at least one second irradiation section, the second irradiation section being not parallel to the first irradiation section, define a second correction direction having an angle in a range from 70° to 110° with regard to the at least one second irradiation section, instruct the optical detection device to obtain a second image of process radiation at locations where the irradiation beam impinges on the second powder layer during irradiation along the at least one second irradiation section, and determine, based on the second image, a correction value along the second correction direction for calibration of the irradiation device.

The first irradiation section may be a straight irradiation vector.

The first irradiation section may be a first irradiation vector being part of a first hatch pattern of a first layer of the three-dimensional workpiece to be produced. The second irradiation section may be a second irradiation vector being part of a second hatch pattern of a second layer of the three-dimensional workpiece to be produced The first hatch pattern and the second hatch pattern may each comprise a plurality of parallel irradiation vectors.

According to a third aspect, a computer program product is provided, which, when carried out by an apparatus for producing a three-dimensional workpiece, instructs the apparatus to perform the method of the first aspect.

The apparatus for producing the three-dimensional workpiece may be the apparatus of the second aspect. In particular, the computer program product may be carried out by a control device or control unit of the apparatus.

Preferred embodiments of the invention are described in greater detail with reference to the appended schematic drawings, wherein

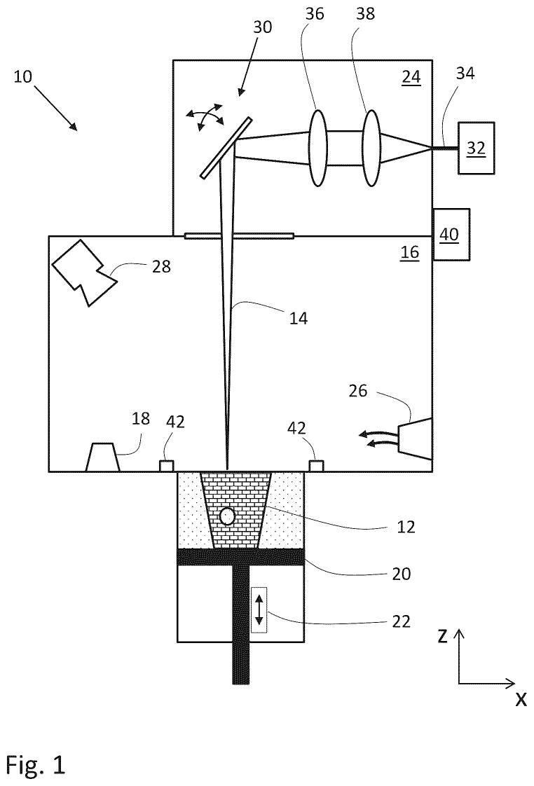

FIG. 1 shows a schematic representation of an apparatus for producing a three-dimensional workpiece via additive manufacturing, according to the present disclosure;

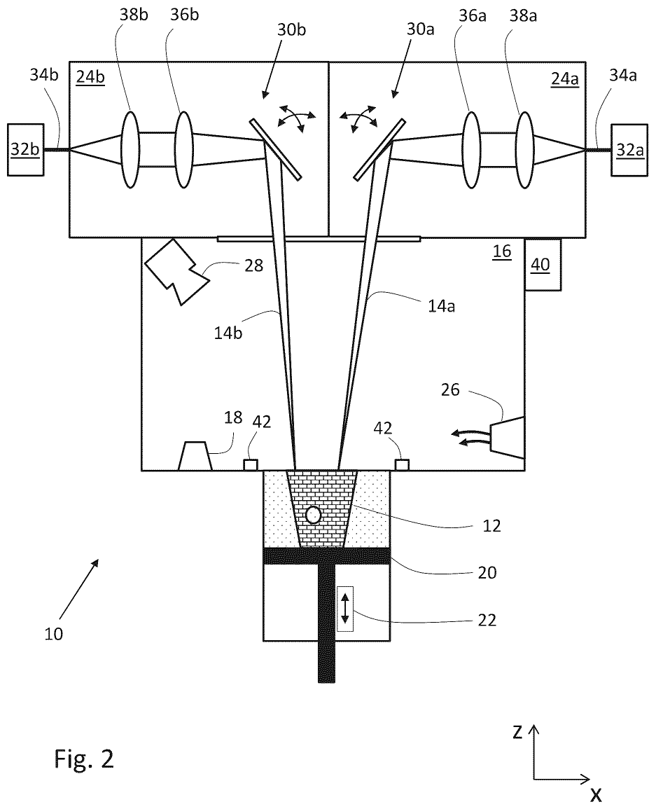

FIG. 2 shows a schematic representation of an apparatus for producing a three-dimensional workpiece via additive manufacturing including two irradiation devices, according to the present disclosure;

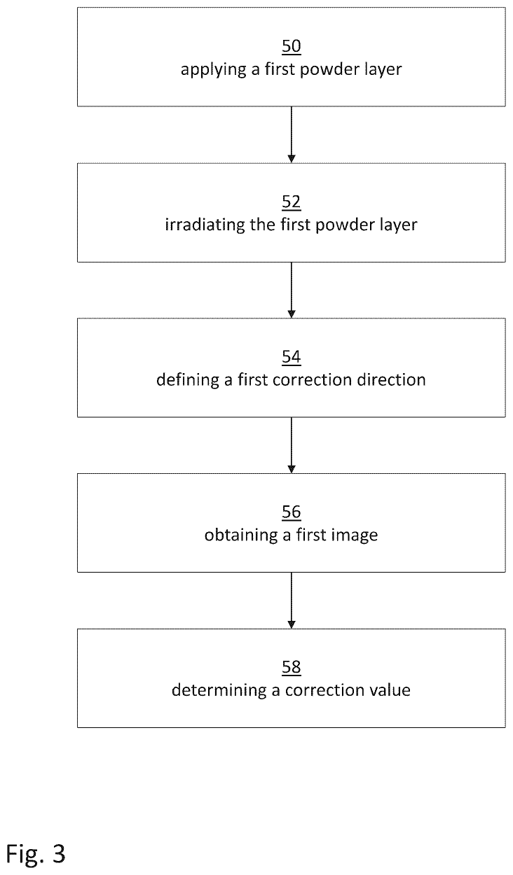

FIG. 3 shows a flow chart of a method for calibrating an irradiation device of an apparatus for producing a three-dimensional workpiece, according to the present disclosure;

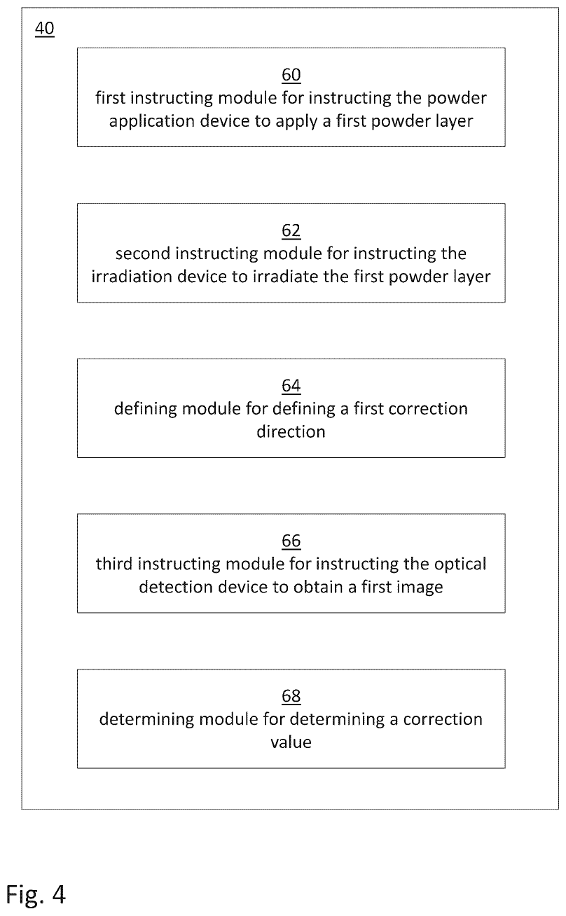

FIG. 4 shows a schematic representation of a control unit of an apparatus for producing a three-dimensional workpiece via additive manufacturing, according to the present disclosure;

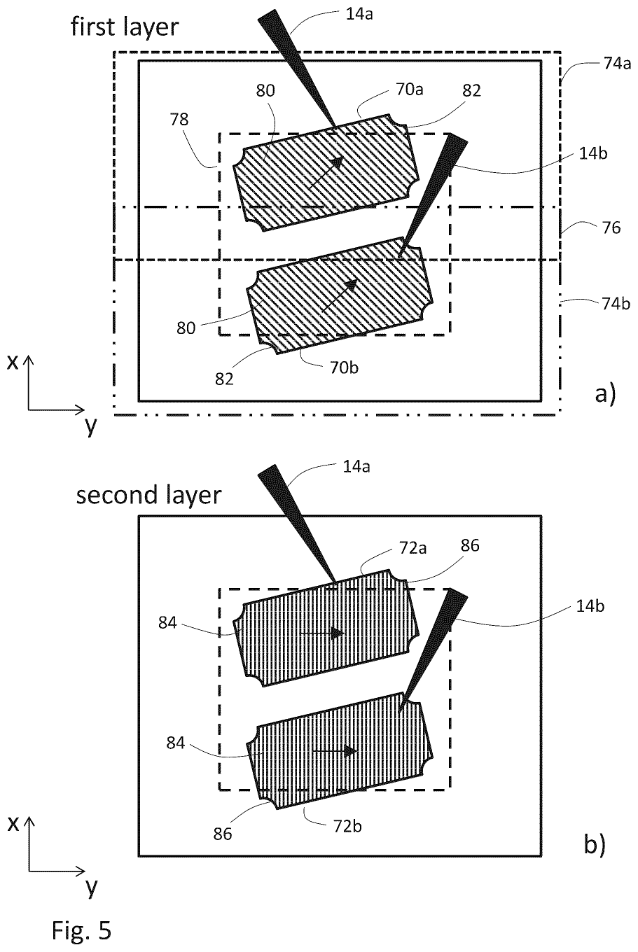

FIG. 5 a) shows a top view of a first layer of a workpiece irradiated with two irradiation beams, wherein the layer of the workpiece is filled with a hatch pattern in a first direction; and

FIG. 5 b) shows a top view of a second layer of the workpiece of FIG. 5 a), wherein the layer of the workpiece is filled with a hatch pattern in a second direction, different from the first direction.

FIG. 1 shows a schematic representation of an apparatus 10 for producing a three-dimensional workpiece 12. The apparatus 10 is, in general, apart from the method of calibration programmed into a control unit 40 of the apparatus 10, well known to the person skilled in the art. The apparatus 10 may be, e.g., a typical additive manufacturing apparatus, wherein the method for calibrating the irradiation device 24, according to the present disclosure, is programmed into a control unit 40 of the apparatus 10.

The principles of the apparatus 10 are well known to the person skilled in the art in the field of additive manufacturing and will only be described briefly. For example, such an apparatus 10 may be an apparatus for selective laser melting or an apparatus for selective laser sintering, wherein one or more laser beams 14 may be used for selectively irradiating and solidifying subsequent layers of raw material powder.

The apparatus 10 for carrying out a process of selective laser melting as described below may serve as an example. Typical features of powder bed fusion are that a raw material powder is applied in layers and each layer is selectively irradiated and solidified in order to generate one layer of a workpiece 12 to be produced. After removing excess powder, and after optional steps of post processing (e.g., removing one or more support structures), the final workpiece 12 is obtained.

FIG. 1 shows an apparatus 10 for producing a three-dimensional workpiece 12 by selective laser melting. The apparatus 10 comprises a process chamber 16. The process chamber 16 is sealable against the ambient atmosphere, i.e. against the environment surrounding the process chamber 16. A powder application device 18, which is arranged in the process chamber 16, serves to apply a raw material powder onto a carrier 20. A vertical movement unit 22 is provided, such that the carrier 20 can be displaced in a vertical direction so that, with increasing construction height of the workpiece 12, as it is built up in layers from the raw material powder on the carrier 20, the carrier 20 can be moved downwards in the vertical direction.

Since the movability of the carrier 20 by means of the vertical movement unit 22 is well known in the field of selective laser melting, it will not be explained in detail herein. As an alternative to the movable carrier 20, the carrier 20 may be provided as stationary (or fixed) carrier (in particular, with regard to the vertical z-direction), wherein the irradiation device 24 (see below) and the process chamber 16 are configured to be moved upwards during the build process (i.e., with increasing construction height of the workpiece 12). Further, both the carrier 20 and the irradiation device 24 may be individually movable along the z-direction.

A carrier surface of the carrier 20 defines a horizontal plane (an x-y-plane), wherein a direction perpendicular to said plane is defined as a vertical direction or build direction (z-direction). Hence, each uppermost layer of raw material powder and each layer of the workpiece 12 extend in a plane parallel to the horizontal plane (x-y-plane) defined above.

The apparatus 10 further comprises a gas inlet 26 for supplying an inert gas (e.g., argon) into the process chamber 16. A gas outlet (not shown) may be provided, such that a continuous stream of gas may be generated through the process chamber 16 by implementing a gas circuit. In a preferred embodiment, a unidirectional laminar flow is generated over the uppermost raw material powder layer.

Further, a camera 28 is arranged in the process chamber 16, for observing the laser beam 14 directed by the irradiation device 24 towards the powder bed during operation and/or for observing irradiated regions during and/or after irradiation by the laser beam 14. Further, by blocking a wavelength of the laser beam 14 with a respective optical filter, only the heat radiation of a generated melt pool may be observed (also referred to herein as melt pool radiation). The camera 28 may be part of a melt pool observation device. A field of view of the camera 28 includes either an entire uppermost powder layer or a section thereof.

The apparatus 10 further comprises an irradiation device 24 (also referred to as irradiation unit or optical unit) for selectively irradiating the laser beam 14 onto the uppermost layer of raw material powder applied onto the carrier 20. By means of the irradiation device 24, the raw material powder applied onto the carrier 20 may be subjected to laser radiation in a site-selective manner in dependence on the desired geometry of the workpiece 12 that is to be produced.

The irradiation device 24 comprises a scanning unit 30 configured to selectively irradiate the laser beam 14 onto the raw material powder applied onto the carrier 20. The scanning unit 30 is controlled by a control unit 40 of the apparatus 10. The scanning unit 30 may comprise one mirror tiltable with regard to two perpendicular axes. Alternatively, the scanning unit 30 may comprise two tiltable mirrors, each configured to be tilted with regard to a corresponding axis. The tiltable mirrors may be, e.g., galvanometer mirrors.

The irradiation device 24 is supplied with laser radiation from a laser beam source 32. The laser beam source 32 may be provided within the irradiation device 24 or outside the irradiation device 24, as shown in FIG. 1. In the first case, the laser beam source 32 may be regarded as being part of the irradiation device 24. In the latter case, the laser beam is generated by the laser beam source 32 and guided into the irradiation device 24 via an optical fiber 34. Alternatively, the laser beam may be guided into the irradiation device 24 through the air or through a vacuum, e.g., by using one or more mirrors.

From the laser beam source 32, the laser beam is directed to the scanning unit 30. The laser beam source 32 may, for example, comprise a diode pumped Ytterbium fiber laser emitting laser light at a wavelength of approximately 1070 to 1080 nm (i.e., in the infrared wavelength range).

The irradiation device 24 further comprises two lenses 36 and 38, which are configured to focus the laser beam 14 onto a desired focus position along the z-axis. In the embodiment shown in FIG. 1, both lenses 36 and 38 have positive refractive power. The lens 38 further upstream of the beam path is configured to collimate the laser light emitted by the fiber 34, such that a collimated or substantially collimated laser beam is generated. The lens 36 further downstream of the beam path is configured to focus the collimated (or substantially collimated) laser beam onto a desired z-position.

Further, reference marks 42 are shown in FIG. 1. The reference marks 42 are provided in a bottom region of the process chamber 16, next to the uppermost layer of raw material powder. At least one of the reference marks 42 are within a field of view of the camera 28. As described below, the reference marks 42 may be used for absolute calibration of the irradiation device 24. However, e.g., for the case that the irradiation 24 device shall only be calibrated relative to another irradiation device (relative calibration), the reference marks 42 are not necessary. Therefore, they are considered optional.

The control unit 40 comprises a processor and a memory, wherein, on the memory, instructions are stored for controlling the individual components of the apparatus 10. For example, the control unit 40 may be configured to control one or more of the camera 28, the vertical movement unit 22, the powder application device 18, a gas flow supplied by the gas inlet 26, and the irradiation device 24. A user input and output interface may be provided and connected or connectable to the control unit 40. Further, the control unit 40 has an interface to receive workpiece data representative of a three-dimensional shape of the workpiece 12 to be produced.

FIG. 2 shows a different embodiment of an apparatus 10, similar to the apparatus 10 of the embodiment of FIG. 1. As only difference between the two apparatuses 10, the apparatus 10 of FIG. 2 comprises two irradiation devices 24a and 24b instead of the one irradiation device 24 of the apparatus 10 of FIG. 1. However, the rest of the apparatus 10 of FIG. 2 has the same components and functions as those discussed above with regard to FIG. 1, such that a repetition of this description is omitted. Further, the components of the irradiation devices 24a and 24b have the same reference signs as those of FIG. 2. However, suffixes “a” and “b” are used in order to distinguish between components of the irradiation device 24a (suffix a) and the components of the further irradiation device 24b (suffix b). The function of the individual components within the irradiation devices 24a and 24b is the same as discussed above with regard to the irradiation device 24.

In the following, the use of a reference sign without suffix (a or b) also refers to the respective elements with the suffixes a and b, if not explicitly indicated otherwise.

For example, when it is referred to the “scanning unit 30”, it is thereby also referred to the scanning units 30a and 30b.

The apparatus 10 of FIG. 2 is configured such that the irradiation device 24a is configured to scan a first predefined region (i.e., a first scan field) of the uppermost powder layer. Similarly, the further irradiation device 24b is configured to scan a second predefined region (i.e., a second scan field) of the uppermost powder layer. The first scan field and the second scan field overlap each other in an overlap area. In other words, there is a region of the uppermost powder layer that can be reached and selectively irradiated by both laser beams 14a and 14b (i.e., the overlap area). The first scan field and the second scan field may be each rectangular or circular and a size and/or shape of the respective scan field may be predefined by a range of movement of the respective scanning unit 30a and 30b of the irradiation devices 24a and 24b, respectively.

For producing the three-dimensional workpiece 12, both laser beams 14a and 14b can simultaneously irradiate different sections of the same powder layer, wherein each laser beam 14a and 14b irradiates a section of the workpiece 12 in its corresponding scan field. In this way, the workpiece 12 can be built up faster than in a case where only one laser beam 14 is used (see, e.g., FIG. 1).

However, for achieving a high quality of the generated workpiece 12, it is important that the two lasers 14a and 14b are calibrated with regard to each other. In other words, it is important that a relative position of the first laser beam 14a with regard to the second laser beam 14b is known. For example, when both laser beams 14a and 14b shall irradiate the same spot (or one laser beam shall continue to irradiate a line started by the other laser beam), a proper relative calibration is required.

Further, also for the case of only one irradiation device 24 (see FIG. 1) and for the case of more than one irradiation devices 24a, 24b (see FIG. 2), it may be important to provide an absolute calibration, i.e., a calibration with regard to positions of the uppermost powder layer. For example, it may be important, e.g., for a case of hybrid manufacturing, where an object to be repaired is embedded in the powder bed below the uppermost powder layer, to hit a specific predefined position within the uppermost powder layer in order to continue a build of the object to be repaired.

The technique of the present disclosure provides an absolute and/or relative calibration of one or more irradiation devices, as discussed above. Providing a calibration (and, in particular, a constant calibration or a calibration in short time intervals) is particularly important in case irradiation devices 24 are used that do not exhibit the same stability as high cost high precision irradiation devices. Cheaper irradiation devices 24 may comprise cheaper components that exhibit a significant drift (e.g. long-term drift or short-term drift), such as thermal drift during heating of individual components (e.g., lenses) of the irradiation device 24 during a build process. Drift may include, in particular, drift of a position of the laser beam 14 in the x-y-plane with regard to a fixed position of the uppermost powder layer. In other words, although the respective irradiation device 24 is instructed (e.g., by respective commands) to irradiate a particular position of the uppermost powder layer, an actually irradiated position changes over time and, thereby, “drifts”.

Further, the method described herein may also be very useful for high cost and/or high precision irradiation devices since also these (expensive) irradiation devices may struggle with drift within the x-y-plane. In this case, the proposed method may serve to further increase the precision of the multi-laser alignment and the precision of the generated workpieces.

The above-described drift phenomena can be avoided by providing a calibration as described in the present disclosure.

FIG. 3 shows a flow chart of a method for calibrating an irradiation device 24 of an apparatus 10 for producing a three-dimensional workpiece 12, according to the present disclosure.

The method is carried out during a build process of a three-dimensional workpiece 12, e.g., with one of the apparatuses 10 of FIG. 1 or FIG. 2 described above.

The method starts with a step 50 of applying a first powder layer onto a carrier or onto a previously applied powder layer. The applying is carried out with the powder application device 18 and under the control of the control unit 40. The first powder layer extends within an x-y-plane and has a predefined thickness. The first powder layer may be an actual first (i.e., initial) powder layer of the build process or it may be a powder layer applied during the course of the build process after previous powder layers have already been applied.

In a step 52, the first powder layer is irradiated along at least one first irradiation section. The irradiation is carried out by the irradiation device 24 or 24a. Irradiation takes place with an irradiation beam and, in particular, with the laser beam 14 of the apparatus 10 of FIG. 1 or with the laser beam 14a of the apparatus 10 of FIG. 2. The first irradiation section may be a section of a straight line and may have a start point and an end point, wherein the irradiation beam is scanned from the start point to the end point. During the irradiation, the powder is melted or sintered at regions irradiated by the irradiation beam. More precisely, a melt pool is formed of melted, liquid powder material, which subsequently cools down and thereby solidifies. This leaves a solidified line of powder material along the irradiation section after irradiation.

In a step 54, a first correction direction is defined having an angle in a range from 70° to 110° with regard to the at least one first irradiation vector. The angle may be 90°. The definition of the first correction direction is carried out by the control unit 40 of the device 10. More precisely, the control unit 40 has the relevant information of a scanning direction of the first irradiation section and, therefore, can define the first correction direction on the basis of this information. For example, in case the first irradiation section is scanned along the x-direction (1,0), the first correction direction may be defined along the y-direction (0,1). The first irradiation section and the first correction direction are within the plane of an uppermost powder layer (i.e., within the x-y-plane).

In a step 56, a first image of process radiation at locations where the irradiation beam impinges on the first powder layer during irradiation along the at least one first irradiation section is obtained. The obtaining is carried out by the camera 28, under the control of the control unit 40. Corresponding image data may be stored and/or processed by the control unit 40.

In a step 58, based on the first image, a correction value along the first correction direction is determined, for calibration of the irradiation device. This step is carried out by the control unit 40. The correction value is suitable to be used for calculating an actual irradiation position along the correction direction, on the basis of position data that was input, e.g., into the scanning unit 30 of the irradiation device 24. The correction value may be representative of an offset along the first correction direction or may be representative of a linear correction factor along the first correction direction. Further, one or more non-linear correction factors may be considered.

On the basis of the correction value along the first correction direction, calibration of the irradiation device 24 may be carried out along the first correction direction. The calibration may be carried out either directly after the steps 50 to 58 or after steps 50 to 58 have been repeated for a different (second) powder layer and, thereby, for a different (second) correction direction. In the first case, calibration is only carried out along the first correction direction. In the latter case, a full x-y-calibration can be carried out since the first and the second correction direction are not parallel to each other.

FIG. 4 shows a schematic representation of the control unit 40 of one of the apparatuses 10 of FIG. 1 or FIG. 2. The control unit 40 comprises several modules 60 to 68, each of which may be represented in the form of hardware and/or software. In one example, the control unit 40 comprises a processor and a memory. On the memory, instructions are stored, which cause the processor to carry out the method shown in FIG. 3. For this purpose, the software stored on the memory may be considered to comprise the modules 60 to 68 shown in FIG. 4.

In detail, these modules are:

First instruction module 60 for instructing the powder application device to apply a first powder layer onto a carrier or onto a previously applied powder layer.

Second instructing module 62 for instructing the irradiation device to irradiate the first powder layer with an irradiation beam along at least one first irradiation section.

Defining module 64 for defining a first correction direction having an angle in a range from 70° to 110° with regard to the at least one first irradiation section.

Third instructing module 66 for instructing the optical detection device to obtain a first image of process radiation at locations where the irradiation beam impinges on the first powder layer during irradiation along the at least one first irradiation section.

Determining module 68 for determining, based on the first image, a correction value along the first correction direction for calibration of the irradiation device.

The details discussed herein with regard to the individual method steps may also apply to the corresponding modules 60 to 68 of the control unit 40. In other words, the control unit 40 is configured to carry out the method of FIG. 3 above, wherein the details of this method discussed herein apply accordingly to the software of the control unit 40 and/or to the corresponding modules shown in FIG. 4 and/or to additional modules.

FIG. 5 shows a build process of one or more three-dimensional workpieces 12 with two laser beams 14a and 14b. For the description of FIG. 5 it is not relevant whether the two irradiated sections 70a/70b and 72a/72b of the respective first layer (FIG. 5 a)) and second layer (FIG. 5 b)) are part of one and the same workpiece 12 or of two different workpieces 12. Both cases are encompassed in the following description, wherein it will be generally referred to “the workpiece 12” (singular).

For the build process shown in FIG. 5, the apparatus 10 of FIG. 2 (with two irradiation devices 24a and 24b) may be used. Further, any other suitable additive manufacturing apparatus capable of emitting at least two irradiation beams may be used for the build process of FIG. 5.

FIG. 5 a) shows the irradiation of a first layer of the workpiece 12, which may be an initial layer (i.e., an actual first layer on the carrier 20) or another arbitrary layer during the build process of the workpiece 12. FIG. 5 b) shows the irradiation of a second layer of the workpiece 12, wherein the second layer may be directly subsequent to the first layer or may be an arbitrary layer of the same workpiece 12 that is irradiated at some point after the irradiation of the first layer.

Similar to the discussion of FIG. 2, an area of the carrier 20, which defines a total footprint of a workpiece 12 to be generated, is separated into two scan fields 74a and 74b. The first scan field 74a defines an area of the uppermost powder layer that can be irradiated by the first laser beam 14a, whereas the second scan field 74b defines an area of the uppermost powder layer that can be irradiated by the second laser beam 14b. In other words, each of the laser beams 14a and 14b can be scanned to every position within their respective scan field 74a and 74b with the help of the scanning unit 30a, 30b of their respective irradiation device 24a, 24b.

The two scan fields 74a and 74b define an overlap area 76, in which the two scan fields 74a and 74b overlap. The overlap area 76 can be reached by both laser beams 14a and 14b. Irradiation in the respective scan fields 74a and 74b (and within the overlap area 76) can be carried out simultaneously or subsequently.

In FIG. 5, a field of view 78 of the camera 28 is also indicated. The field of view 78 is defined as the area of the uppermost powder layer that is imaged by the camera 28 when an image is obtained by the camera 28. As shown in FIG. 5, the field of view 78 covers at least a section of the overlap area 78. Further, in the embodiment of FIG. 5, also a section of the first scan field 74a and the second scan field 74b, which is respectively not part of the overlap area 76, is covered by the field of view 78.

The first layer of the workpiece 12 comprises a first section 70a and a second section 70b. According to an irradiation strategy stored and/or defined in the control unit 40, the first section 70a is irradiated with the first laser beam 14a and the second section 70b is irradiated with the second laser beam 14b. The same holds for the sections 72a and 72b of the second layer, which may be identical in shape with regard to the sections 70a and 70b or not.

In the first layer, the scan strategy comprises a hatch pattern defining a plurality of parallel irradiation vectors 80. Although only one irradiation vector 80 is provided with a reference sign in both the first section 70a and the second section 70b, it should be kept in mind that a plurality of irradiation vectors 80 is defined in each of the first and second sections 70a and 70b. The hatch pattern defines a plurality of parallel irradiation vectors 80 to be used as a filling in an inner part (also referred to as core) of the workpiece 12. In addition to the hatched inner part, a contour 82 is provided along which a contour of the workpiece 12 is solidified. The contour 82 may be irradiated with the same laser beam 14a, 14b as the corresponding hatch pattern (vectors 80) or with a different laser beam (or with the same laser beam but with different irradiation parameters, e.g., irradiation power).

Arrows in FIG. 5 a) indicate a direction perpendicular to a direction of the individual irradiation vectors 80. As discussed below, this direction (according to the arrows) corresponds to a first correction direction.

In the second layer shown in FIG. 5 b), the scan strategy also comprises a hatch pattern defining a plurality of parallel irradiation vectors 84. Although only one irradiation vector 84 is provided with a reference sign in both the first section 72a and the second section 72b, it should be kept in mind that a plurality of irradiation vectors 84 is defined in each of the first and second sections 72a and 72b. The hatch pattern defines a plurality of parallel irradiation vectors 84 to be used as a filling in an inner part (also referred to as core) of the workpiece 12. In addition to the hatched inner part, a contour 86 is provided along which a contour of the workpiece 12 is solidified. The contour 86 may be irradiated with the same laser beam 14a, 14b as the corresponding hatch pattern (vectors 84) or with a different laser beam (or with the same laser beam but with different irradiation parameters, e.g., irradiation power).

Arrows in FIG. 5 b) indicate a direction perpendicular to a direction of the individual irradiation vectors 84. As discussed below, this direction (according to the arrows) corresponds to a second correction direction.

As shown in FIG. 5, a direction of the irradiation vectors 80 and 84 is different. In other words, the direction, along which the irradiation vectors 80 and 84 extend, is rotated between the first layer and the second layer. For example, the scan strategy may involve a rotation of irradiation vectors for every layer, e.g., about 45° or 90°. A rotation of the direction of the irradiation vectors within the x-y-plane may be carried out, e.g., for every layer or for every N layers, wherein N is 2 or more. For the discussion of the present embodiment, it is merely important that the (first) irradiation vectors 80 of the first layer and the (second) irradiation vectors 84 of the second layer are not parallel to each other.

In the following, it is explained how the irradiation of the irradiation vectors 80 and 84, which is carried out for producing the three-dimensional workpiece 12, can be used for calibrating the corresponding irradiation devices 24a and 24b. In the following, calibration of the first irradiation device 24a is described, wherein the calibration of the second irradiation device 24b is carried out in an analogous manner.

The irradiation of the irradiation vector 80 is carried out on the basis of a scan strategy stored in the control unit 40. Hence, the direction of the irradiation vector 80 is predefined by scan data stored in the control unit 40.

On the basis of the scan strategy and/or the scan data, the control unit 40 defines a first correction direction perpendicular to the first irradiation vector 80.

The camera 28 obtains a first image (covering the field of view 78) of at least a section of one of the irradiation vectors 80. In other words, the camera 28 is operated with a predefined exposure time, which covers the irradiation of at least a section of one of the irradiation vectors 80. According to an embodiment, the direction of the irradiation vector 80 can be derived from the obtained image. Hence, the image does not only show one single one-dimensional irradiation spot. In one example considered in the present embodiment, an exposure time of the camera 28 is chosen such that one full irradiation vector 80 is part of the image. Each one of the irradiation vectors 80 has a start point and an end point, wherein the laser beam 14a and 14b is used for scanning the respective irradiation vector 80 from its start point to its end point. In the discussed example, the exposure time is chosen such that it covers at least the scanning from the start point to the end point. Thus, the direction of the irradiation vector 80 can be obtained from the image.

However, according to another embodiment, the exposure time is so short that the image only shows one single one-dimensional irradiation spot. In this case, a direction of the first irradiation vector 80 is known, since it can be derived from the scan strategy and/or the scan data.

In the present example using two laser beams 14a and 14b, the image includes one irradiation vector irradiated by the first laser beam 14a and one irradiation vector irradiated by the second laser beam 14b. Of course, the image may include further irradiation vectors (or section(s) of irradiation vectors), e.g., irradiated before or after the considered irradiation vector 80.

The control unit 40 analyses the first image and, in particular, determines a position of the first irradiation vector 80 with regard to the first correction direction. In the control unit 40, a desired position of the first irradiation vector 80 is stored, such that a deviation of the obtained position with regard to the desired position may be calculated. For example, an offset value (e.g., in mm) may be calculated defining an offset of the desired position from the actual position within the image. The offset value is also referred to as a first correction value. Other possibilities of a first correction value are a correction factor (for linear multiplication) or a parameter to be applied in a non-linear correction function.

In a subsequent calibration step, carried out by the control unit 40, a calibration of the irradiation device 24a is carried out on the basis of the first correction value. The calibration is carried out along the first correction direction by using the first correction value. For example, the calibration may be carried out such that the first correction value is applied by the control unit 40 to position data transferred to the irradiation device 24a and, more precisely, to the respective scan unit 30a. As mentioned above, the calibration of the second irradiation device 24b is carried out in the same manner as explained above with regard to the first irradiation device 24a.

Further, the calibration of the irradiation devices 24a and 24b may be absolute or relative to each other.

Absolute calibration means a calibration with regard to a fixed position of the carrier 20 and, therefore, of the powder bed. For this purpose, the camera 28 has to be calibrated in advance, e.g., by using reference marks 42 provided, e.g., in a side region next to the uppermost powder layer, as shown in FIGS. 1 and 2. More precisely, an image field correction may be carried out by using a plurality of reference marks 42. As an alternative to using reference marks 42 in a side region next to the powder bed, a calibration carrier may be used, which is placed into the process chamber 16 at a fixed position with regard to the carrier 20. In each case, the camera 28 records an image of the calibration marks and the control unit 40 is used to map positions in the recorded image to actual positions on the carrier 20.

Relative calibration means that the first laser beam 14a is calibrated with regard to the second laser beam 14b, such that a relative position with regard to the laser beams 14a and 14b is known and can be controlled. For example, in case the two scanning units 30a and 30b are instructed to irradiate the same spot within the overlap region 76, the two laser beams can be directed to a same spot. However, in case an absolute calibration has not been carried out, the position of the spot within the uppermost powder layer may not be exactly known.

For the second layer shown in FIG. 5 b), calibration is carried out as described above with regard to the first layer of FIG. 5 a). However, the direction of the second irradiation vectors 84 is different from the direction of the first irradiation vectors 80, such that, in combination, the calibration after the first layer and the calibration after the second layer leads to a full calibration with regard to both x- and y-direction (i.e., with in the x-y-plane).

In an alternative approach, after the irradiation of the first layer, the first correction value is obtained and after the irradiation of the second layer, the second correction value is obtained. In a subsequent calibration step, calibration is performed on the basis of the first correction value and the second correction value. As a result, calibration is performed with regard to both the x- and y-direction.

Calibration according to the present technique may be also described as follows. An evaluation software is stored in the control unit 40. The evaluation software comprises an interface to a scanner controller device used for controlling a position and/or a deflection of the scanning unit 30. The interface is used for obtaining a current position of the scanning unit 30 (in particular, of the scanner mirrors of the scanning unit 30) in a timely synchronized manner. A software automatically evaluates the images, in order to obtain the actual position of the laser beam 14a.

Optionally, interpolation may be carried out between pixels, in order to obtain higher resolution. Further, detected deviations between actual position and desired position of the laser spot are corrected, in particular, for lists of scanning vectors sent to the scanner controller device or even for each coordinate sent to the scanning unit 30.

In the following, alternative or modified approaches with regard to the embodiment of FIG. 5 discussed above are discussed. If applicable, the following alternatives may be carried out in conjunction with the technique discussed above.

According to a first alternative, an apparatus 10 with only one irradiation device 24 (such as the apparatus 10 of FIG. 1) is calibrated or only one irradiation device 24a or 24b of an apparatus 10 with more than one irradiation devices is calibrated. For this purpose, the method is the same as discussed above, wherein only the first sections 70a and 70b are considered.

According to a second alternative, a direction of the first irradiation vectors 80 of the first section 70a is different from a direction of the first irradiation vectors 80 of the second section 70b. In general, a direction of the irradiation vectors of the first irradiation device 24a may be different from a direction of the irradiation vectors of the second irradiation device 24b. However, the method of calibration is the same as discussed above. In this case, the first correction direction of the first irradiation device 24a is different from the correction direction of the second irradiation device 24. The same may apply to the second layer.

The above technique may be carried out such that, in the step of determining a correction value along the first correction direction, no correction value along a different, perpendicular, correction direction is obtained. Thus, in a first correction step carried out after irradiation of the first layer, calibration is exclusively carried out with regard to the first correction direction (and not with regard to a further correction direction). In other words, the calibration carried out after the irradiation of the first layer may be one-dimensional. Similarly, the calibration after irradiation of the second layer may be one-dimensional.

However, according to a third alternative, the start points and/or end points of the first irradiation vectors may be considered and used for carrying out a calibration with regard to a direction perpendicular to the first correction direction. Similarly, the start points and/or end points of the second irradiation vectors may be considered and used for carrying out a calibration with regard to a direction perpendicular to the second correction direction. However, these “perpendicular” calibrations may not be as precise as the corresponding calibrations with regard to the first and second correction directions.

According to a fourth alternative, more than one camera 28 may be used and, for the calibration, a combined field of view of the cameras may be considered.

Further, according to a fifth alternative a movable camera 28 may be used, which can move its field of view over the carrier 20 to provide a larger field of view. Further, a camera of a process observation system of a laser optics may be used as the camera 28.

According to a sixth alternative, a contour section of the contour 82 of the first layer and/or a contour section of the contour 86 of the second layer is considered for determining the correction value. The contour section may be a straight line (as shown in FIG. 5 with regard to the sides of the substantially rectangular shapes of the irradiation pattern) or it may be a curved line (as shown in FIG. 5 with regard to the corner sections of the substantially rectangular shapes of the irradiation pattern).

The contour section of the contour 82, 86 may be considered in addition to the irradiation vectors 80, 84 for calibration of the respective irradiation device 24. The contour section is treated similar to the irradiation vector 80 and 84 discussed above. Thus, a correction direction is defined perpendicular to the contour section and a corresponding correction value is calculated.

In case the contour section is a straight contour section (e.g., one of the straight lines of the contour shown in FIG. 5), the correction direction is defined, in this case, perpendicular to the straight contour section. However, the considered contour section may also be a curved contour section (e.g., one of the corner sections of the contour shown in FIG. 5). In this case, the correction direction is defined perpendicular to a tangential direction of the contour section at a considered point.

One or more embodiments of the present technique may have at least one of the following advantages. Since calibration can be carried out during an actual build process, no time-consuming calibration has to be carried out in advance. More precisely, embodiments described herein may have an advantage that calibration information is obtained without disturbance of the regular ongoing build process, simply by observing the build process. Further, since calibration is carried out for every layer or for every N layers during the build process, it can be ensured that the irradiation device are constantly calibrated and drift is compensated at all times during the build process. In this way, less expensive irradiation devices may be used, which have a significant drift, while an accuracy of the irradiated position can be ensured.

1-15. (canceled)

16. A method for calibrating an irradiation device of an apparatus for producing a three-dimensional workpiece, the method comprising:
applying a first powder layer onto a carrier or onto a previously applied powder layer;
irradiating the first powder layer with an irradiation beam along at least one first irradiation section;
defining a first correction direction having an angle in a range from 70° to 110° with regard to the at least one first irradiation section;
obtaining a first image of process radiation at locations where the irradiation beam impinges on the first powder layer during irradiation along the at least one first irradiation section; and
determining, based on the first image, a correction value along the first correction direction for calibration of the irradiation device.

17. The method according to claim 16, further comprising:
applying a second powder layer onto the first powder layer or onto a powder layer that has been applied after the first powder layer;
irradiating the second powder layer with the irradiation beam along at least one second irradiation section, the second irradiation section being not parallel to the first irradiation section;
defining a second correction direction having an angle in a range from 70° to 110° with regard to the at least one second irradiation section;
obtaining a second image of process radiation at locations where the irradiation beam impinges on the second powder layer during irradiation along the at least one second irradiation section; and
determining, based on the second image, a correction value along the second correction direction for calibration of the irradiation device.

18. The method according to claim 16, wherein the first irradiation section is a straight irradiation vector.

19. The method according to claim 18, wherein
the first irradiation section is a first irradiation vector being part of a first hatch pattern of a first layer of the three-dimensional workpiece to be produced, and
the second irradiation section is a second irradiation vector being part of a second hatch pattern of a second layer of the three-dimensional workpiece to be produced.

20. The method according to claim 19, wherein
the first hatch pattern and the second hatch pattern each comprise a plurality of parallel irradiation vectors.

21. The method according to claim 19, wherein
the at least one first irradiation vector and the at least one second irradiation vector form an angle of more than 10°, more than 15°, or more than 20°.

22. The method according to claim 18, wherein
the first image includes a start point and an end point of the first irradiation vector.

23. The method according to claim 16, wherein
the first irradiation section is a contour section being part of a contour (82, 86) of the three-dimensional workpiece to be produced.

24. The method according to claim 16, wherein the apparatus comprises an irradiation device for irradiating the irradiation beam and a further irradiation device for irradiating a further irradiation beam, the method comprising:
selectively irradiating the further irradiation beam onto the first powder layer, wherein
the irradiation device is configured to scan the irradiation beam over a first scan field and the further irradiation device is configured to scan the further irradiation beam over a second scan field, at least partially overlapping the first scan field in an overlap area, and wherein
an optical detection device obtaining the first image is oriented or orientable such that a field of view of the optical detection device comprises at least a section of the overlap area.

25. The method of claim 24,
wherein the irradiation device and the further irradiation device simultaneously irradiate in the overlap area and are simultaneously imaged by the optical detection device, or
wherein the irradiation device and the further irradiation device sequentially irradiate in the overlap area and are sequentially imaged by the optical detection device.

26. An apparatus for producing a three-dimensional workpiece, comprising:
a powder application device configured to apply at least one powder layer onto a carrier or onto a previously applied powder layer;
an irradiation device for selectively irradiating an irradiation beam onto an irradiation plane corresponding to the applied powder layer;
an optical detection device for optically detecting at least a portion of the irradiation plane; and
a control unit configured to:
instruct the powder application device to apply a first powder layer onto the carrier or onto the previously applied powder layer;
instruct the irradiation device to irradiate the first powder layer along at least one first irradiation section;
define a first correction direction having an angle in a range from 70° to 110° with regard to the at least one first irradiation section;
instruct the optical detection device to obtain a first image of process radiation at locations where the irradiation beam impinges on the first powder layer during irradiation along the at least one first irradiation section; and
determine, based on the first image, a correction value along the first correction direction for calibration of the irradiation device.

27. The apparatus according to claim 26, wherein the control unit is configured to:
instruct the powder application device to apply a second powder layer onto the first powder layer or onto a powder layer that has been applied after the first powder layer;
instruct the irradiation device to irradiate the second powder layer with the irradiation beam along at least one second irradiation section, the second irradiation section being not parallel to the first irradiation section;
define a second correction direction having an angle in a range from 70° to 110° with regard to the at least one second irradiation section;
instruct the optical detection device to obtain a second image of process radiation at locations where the irradiation beam impinges on the second powder layer during irradiation along the at least one second irradiation section; and
determine, based on the second image, a correction value along the second correction direction for calibration of the irradiation device.

28. The apparatus according to claim 26, wherein the first irradiation section is a straight irradiation vector.

29. The apparatus according to claim 28, wherein
the first irradiation section is a first irradiation vector being part of a first hatch pattern of a first layer of the three-dimensional workpiece to be produced, and
the second irradiation section is a second irradiation vector being part of a second hatch pattern of a second layer of the three-dimensional workpiece to be produced, and, optionally, wherein
the first hatch pattern and the second hatch pattern each comprise a plurality of parallel irradiation vectors.

30. A computer program product, which, when carried out by an apparatus for producing a three-dimensional workpiece, instructs the apparatus to perform the method of claim 16.
